(19) United States
(12) Patent Application Publication
(10) Pub. No.: US 2009/0146534 A1
(43) Pub. Date: Jun. 11, 2009

(54) Piezoelectric Generator

(76) Inventors: Klaus Reichmann, Graz (AT); Igor Kartashev, Deutschlandsberg (AT); Wolfgang Athenstaedt, Graz (AT)

Correspondence Address: SLATER & MATSIL, L.L.P., 17950 PRESTON RD, SUITE 1000, DALLAS, TX, 75252-5793, US

(21) Appl. No.: 12/336,304

(22) Filed: Dec. 16, 2008

Related U.S. Application Data
(63) Continuation of application No. PCT/DE2007/001093, filed on Jun. 20, 2007.

(30) Foreign Application Priority Data
Jun. 21, 2006 (DE) 102006028534.4

(51) Int. Cl. H02N 2/18

(52) U.S. Cl. 310/339

(57) ABSTRACT

A piezo-generator is specified with a resonance system which includes a piezoelectric transducer. The generator includes a feedback circuit, which is connected to the output of the piezoelectric transducer, that is provided for setting the oscillation frequency of the resonance system.

This application is a continuation of co-pending International Application No. PCT/DE2007/001093, filed Jun. 20, 2007, which designated the United States and was not published in English, and which claims priority to German Application No. 10 2006 028 534.4 filed Jun. 21, 2006, both of which applications are incorporated herein by reference.

### BACKGROUND

A piezoelectric generator is known from, for example, the U.S. Pat. No. 5,751,091. This generator is used in a watch.

### SUMMARY

In one aspect, the present invention specifies a high-efficiency piezo-generator which is characterized by high mechanical stability.

A piezo-generator is known with a resonance system which is excitable by mechanical oscillations. This system comprises a piezoelectrical transducer. Furthermore, the generator comprises a feedback circuit which is electrically connected to the piezoelectric transducer. The feedback circuit is provided for controlling oscillations of the resonance system and especially for adjusting the oscillation frequency of the resonance system.

The piezo-generator is suitable for transformation of mechanical energy into electrical energy. The piezo-generator can be realized, for example, as a power supply in a portable electrical device. The mechanical energy used for excitation of the resonance system can be produced with body movements or movements of the air.

The piezoelectrical transducer is suitable for conversion of mechanical energy of a resonance system into electrical energy that can be fed to an electrical load, i.e., a consumer.

Additional advantageous developments of piezo-generators are described.

The piezoelectric transducer is subsequently called a piezoelectric element.

The mechanical resonance system is preferably mechanically excited by vibrations during the excitation phase. For this purpose, the generator in a preferred embodiment comprises an excitation device which provides for the mechanical excitation of the resonance system during each excitation phase.

Mechanical parameters of the excitation system can be adjusted by means of the feedback circuit. The mechanical parameters of the excitation system are, for example, the specified rotational frequency or speed of the transport device which bears the activator, explained subsequently, for excitation of the resonance system. Thus, the action frequency of the activator is adjusted to the resonance system.

The generator has a starting phase and an operating phase which corresponds to the normal operation of the generator. During the starting phase, the resonance system is first disequilibrated spontaneously or by means of a start device. This triggers mechanical oscillations of the resonance system that produce an electrical signal at the piezoelectric element having a frequency which matches that of the natural frequency of the mechanical resonance system. A part of this signal is converted into a control signal with a feedback circuit, and is used to control the excitation device of the resonance system. The feedback circuit is provided during the starting phase as a corrective for transient oscillation of the resonance system in the operational state. The feedback circuit is preferably used for stabilization of the excitation frequency. The number of excitations of the resonance system per unit time is known as the excitation frequency.

The resonance system achieves a normal operational state after the transient phase. The normal operational phase means mechanical oscillations of the resonance system, preferably at the natural frequency (resonance frequency) of the resonance system. These oscillations are converted into an electrical signal by the piezoelectric element. The functioning of the generator in normal operation is described in the following.

The mechanical resonance system which is formed, for example, by the piezoelectric element and the oscillatory device explained in the following is characterized by a natural frequency. This can be the fundamental frequency or a higher harmonic of the fundamental frequency. The natural frequency of the resonance system preferably matches the nth harmonic of the excitation frequency, where n is a whole number and n≧1. It is advantageous to select the excitation frequency equal to the natural frequency of this resonance system. In that case, n=1. The range of n can preferably be between 2 and 5.

The mechanical action (excitation) on the resonance system which is controlled by means of the feedback circuit is preferably synchronized with the natural oscillation of the resonance system with respect to frequency, phase and the amplitude, i.e., the specified maximum deflection. The resonance system is excited during the excitation phase, which is preferably a maximum of half the oscillation period T of the resonance system. The excitation phase can also last between T/4 and T/2. The excitation phase is thereby preferably synchronized with the oscillation phase, i.e., the maximum deflection with respect to the equilibrium state is effected at a point in time at which, without excitation, one of the amplitude maxima of the (attenuated) natural oscillation of the resonance system would appear.

The resonance system preferably comprises an oscillation device which has oscillatable oscillatory elements between which the piezoelectric element is clamped. The oscillatory elements preferably oscillate counter to each other. It is advantageous if a plane in which the oscillatory elements swing is perpendicular to the direction of the force of gravity. The oscillatory elements can be oscillated freely after an excitation phase in which they are deflected with respect to their rest position.

The oscillation device is preferably arranged to produce compressive stress at the piezoelectric element. The piezoelectric element can be compressed, e.g., by compressive stress along the longitudinal direction. A shear deformation of the piezoelectric element can also be brought about by means of the compressive stress. Deformation of the piezoelectric element clamped in the oscillation device is caused during oscillations of the oscillating element. The mechanical energy of the oscillation device is converted into electrical energy by means of the piezoelectric element.

The oscillation device is preferably provided with prestressing of the piezoelectric element. With a prestressed piezoelectric element, it is possible to achieve an especially high power density of the generator.

The oscillation device has sources of energy coupled mechanically with the oscillating elements in a preferred variant. Weights are suitable as energy storage elements for storing (mechanical) energy; these weights are fixed on the oscillating elements, preferably in the area of the freely oscillatable ends of the oscillating elements.

The generator can comprise an energy reservoir for storing energy, outside the excitation phases of the decoupled oscillating elements. This energy can be used for excitation of the resonance system, wherein the energy consumption is controlled by the feedback circuit. This energy can be fed to the oscillating elements directly or by means of an activator. The energy saved in this reservoir can be converted into free or, while using the activator, forced oscillations of the oscillation device.

The energy reservoir for energy can be designed such that it is suitable for storing energy of uncorrelated mechanical effects. Possible mechanical effects are, e.g., uncorrelated vibrations of a carrier on which the oscillation device is fixed. Even the energy of the pressure air (e.g., from wind and acoustic signals of the environment) can be accumulated in the energy reservoir. The stored energy can be used, for example, to drive the transport device to which the activator is connected. The activator takes energy from the energy reservoir and transfers it to the oscillation device during the excitation phase.

Compressed air is suitable for energy storing. The positive air pressure can be built up by wind, respiration or by compression of shoe soles while walking. The container can be inflatable like an air balloon, wherein overpressure protection is provided in the container.

The container preferably has an inlet opening and an outlet opening. The inlet opening, by means of which air can be pumped in, is provided with a first valve. The outlet opening can be closed with an activator which is conceptualized as a valve. In that case the activator works as a regulator for metered release of stored energy. In this variant, a contact-free regulation of energy transfer to the resonance system is possible. Air is thereby metered and let out of the container, preferably with a preset frequency. Here the air current produced can oscillate the oscillatable components of the resonance system.

A mechanism with a clockwork spring is another option for storing energy.

The excitation device can comprise a metering device and an activator. The metering device can be coupled to the energy reservoir for metered delivery of stored energy. The activator is preferably coupled to the metering device or, e.g., if realized as a valve, at least forms a part of the metering device. Metered delivery means, e.g., an excitation intensity or excitation frequency matched to the energy requirement. The metering device is characterized by means of mechanical parameters whose values can be modified by the feedback circuit. For this purpose, the metering device is preferably coupled to the feedback circuit. A metered delivery of mechanical energy from an energy reservoir is especially advantageous for excitation of oscillations of the oscillation device.

The excitation device can comprise a transport device which is provided for transport of an activator. The transport device has preferably rotatable elements which can be driven, electromagnetically, for example, by control pulses of the feedback circuit. It is possible to adjust the rotational speed of the rotatable elements with the control pulses. Thus the speed and the action frequency of the activator on the resonance system can be controlled.

The activator can be set in motion by the action of an external mechanical force. The activator is preferably a wedge-shaped part which is used to excite oscillations of the oscillation device and it is provided for metered delivery, periodic delivery in normal operation of the generator, of mechanical energy to the resonance system.

The activator preferably passes between the oscillating elements during the excitation phase and presses these apart. During each passage of the activator, energy is stored in the weights which is proportional to the deflection of weights from the current rest position. After the specified maximum deflection, after the end of the excitation phase, this energy can be converted into the energy of free oscillations of the oscillating device. The excitation phase ends as soon as the activator exits the area between the weights. The duration of residence of the activator in this area, i.e., the period of the excitation phase, is selected such that at a maximum it is half the oscillation period of the oscillation device.

The piezo-generator can have a rectifier which is electrically connected to the piezoelectric transducer. Thus, the AC voltage which is produced at the piezoelectric transducer can be rectified. The rectifier is preferably arranged between the piezoelectric transducer and the electrical load. The feedback circuit is preferably fed the rectified signal.

The piezo-generator can have an electrical storage element which is preferably electrically connected to the piezoelectric transducer. A capacitor which is connected to ground can be considered as an electrical storage element. The capacitor smoothes out the rectified generator voltage, which has a ripple. A part of the rectified signal can be used to charge an electrical storage element. The electrical charge which is accumulated in the electrical storage element can be used for power supply of the feedback circuit and for starting the excitation device.

The oscillating elements preferably each have a fixed end and a freely oscillatable end. Each oscillating element can be, e.g., a band-shaped cantilever spring. The oscillating elements can form, for example, the legs of a U-piece which is preferably fixed to a carrier in the area of its connecting part. In a preferred variant, the oscillation device has the shape of a tuning fork. The vibrations of the carrier can bring about free oscillation to the oscillation device. The oscillation device can also be brought to oscillation by air pressure. In both cases, this can take place with or without the activator.

In another variant, the transport device can comprise a conveyor. This conveyor is set in motion by means of transport rollers. The transport rollers are preferably coupled to an energy reservoir for mechanical energy mentioned above. The transport device can alternatively comprise a rotating device in the form of a disk, a wheel, or a ring which can be rotated about a rotational axis and to which is fixed the activator that passes between the oscillating elements during rotation of the wheel, and thereby effects the pressing apart of the oscillating elements.

The piezoelectric element has electrodes and at least one piezoelectrical layer which is arranged between the electrodes. The electrodes can be, for example, external electrodes; they are arranged on the surface of the base body of the piezoelectric element. A piezoelectric layer is arranged between the external electrodes. An electrical charge of the external electrodes takes place due to the deformation of this piezoelectric layer. However, the electrodes can also be internal electrodes which are each arranged between two piezoelectric layers. Preferably, many internal electrodes are present which can be connected in alternating fashion to a first and a second external electrode. A ceramic with piezoelectrical properties is very well suited for the piezoelectrical layers.

The feedback circuit can comprise a comparator and/or an amplifier. A comparator is a circuit for amplitude comparison of analog signals. The electrical energy accumulator can be used for production of a reference voltage for the comparator. This voltage is fed to a first input of the comparator. For this purpose, a voltage divider with a series resistor and a Z-diode connected in reverse-bias to ground is arranged between the first input of the comparator and the electrical energy accumulator. The rectified output voltage of the piezoelectric element is fed to the second input of the comparator.

The metering device can be realized, for example, in a clock. The energy reservoir is preferably coupled to an oscillating element (e.g., pallet, balance staff). The mechanical energy can thereby be converted into kinetic energy of the oscillation motions of the oscillating element. The oscillating element can drive a shaft by means of a wheel or an escape wheel, and can bring this shaft to rotation. The shaft preferably belongs to the transport device or is coupled mechanically to the transport device. The oscillation frequency of the oscillating element can be controlled by the feedback circuit. Thus the rotational frequency of the shaft and therefore the prescribed speed of the activator can be adjusted.

The metering device can comprise a spring which is coupled to a balance staff in one variant, which spring can be wound up by, among other things, a spontaneous mechanical effect. The oscillation frequency of the balance staff can be adjusted by the length of the spring. The length of the spring can be adjusted by means of a clamping element. This is fixedly connected to a movable, for example, electro-mechanically or electro-magnetically controllable element; this element can preferably perform a linear motion.

It is advantageous if the mechanical parameters of the metering device are selected such that the initial frequency or initial speed of the excitation device lies close to the specified operating point. Preferably, the initial frequency of the excitation device is selected below the operating point. The feedback circuit ensures that the frequency of the excitation device is increased during the starting phase. In normal operation, this frequency is held close to the operating point by the feedback.

Frequency control of the metering device can be accomplished in an advantageous way by means of a comparator. The comparator is coupled electrically to the electro-mechanically or electro-magnetically controllable element. The comparator compares the voltage produced at the piezoelectric element to a reference voltage, and outputs a negative control voltage if the prescribed voltage level is exceeded or a positive control voltage if it goes below this level. The electro-mechanically or electro-magnetically controllable element is moved in one direction or the opposite direction depending on the status of the comparator, i.e., depending on the sign of the control voltage. The position of the controllable element determines the mechanical parameters, and thus the frequency of the metering device.

The piezo-generator can have a start device (switch) which is coupled electrically to the electrical energy accumulator or another electrical energy accumulator; this device is provided for triggering the excitation device by means of an electrical pulse. The stored electrical charge of the feedback circuit which starts up the excitation device is thereby supplied. The piezo-generator can also comprise a starting device for triggering the excitation device by means of a mechanical effect on this device. The starting device can be activated manually. Moreover, a switch can be provided for disconnecting the excitation device.

The generator can comprise many resonance systems instead of only one resonance system. Preferably these systems can be excited with the same frequency but different phases.

### BRIEF DESCRIPTION OF THE DRAWINGS

The piezo-generator is explained by means of schematic figures which are not drawn to scale. In the drawings:

FIG. 1 shows a principle layout of a piezo-generator with a feedback circuit;

FIG. 2 shows a principle layout of a piezo-generator with an energy accumulator;

FIG. 3 shows an exemplary realization of the piezo-generator according to FIG. 2 for the construction with many parallel-connected electromechanical transducers;

FIG. 4 shows time dependency of the voltage generated by the parallel-connected electromechanical transducers according to FIG. 3;

FIG. 5 shows another exemplary realization of the piezo-generator according to FIG. 2 for the contraction with many parallel-connected electromechanical transducers;

FIG. 6 shows a detailed view of the piezo-generator with a rectifier in the form of a diode bridge;

FIG. 7 shows an embodiment of the piezo-generator according to FIG. 2 with many parallel-connected electromechanical transducers, wherein an independent activator is provided for each transducer;

FIG. 8 shows, in cross section, the piezo-generator with an oscillating device and prestressed piezoelectric element, wherein the oscillating elements of the oscillating device are deflected by an activator (above) and oscillate freely (below);

FIGS. 9 and 10 show a perspective view of a transport device which sets the activator in motion;

FIG. 11 shows the top view of a transport device with which many activators are mounted on a rotating device in the form of a disk;

FIG. 12 shows the top view of a transport device with which two activators are mounted on a rotating device in the form of a spoke, at both ends of the spoke;

FIG. 13 shows an oscillation device with an accumulator for the compressed air; this device can be excited by the compressed air;

FIG. 14A shows a detailed view of the air chamber according to FIG. 13 with a valve in the form of a flap which is fixed on the air chamber at one end;

FIG. 14B shows a detailed view of the air chamber according to FIG. 13 with a valve in the shape of a membrane;

FIG. 15A shows the view of an inlet opening of an air chamber according to FIG. 13 with a valve in the form of a plate which can be rotated about its central axis, for a closed inlet opening;

FIG. 15B shows the view of an inlet opening of an air chamber according to FIG. 13 with a valve in the form of a plate which can be rotated about its central axis, for an open inlet opening;

FIG. 16 shows an exemplary realization of the feedback circuit; and

FIG. 17 shows the dependency of the voltage produced by the generator on the excitation frequency.

The following list of reference symbols can be used with the drawings:
1 Piezo-generator
2 Piezoelectric element
26 Feedback circuit
261 Comparator
262, 263 Z-diodes
27 Metering device
3 Electrical load
31 Rectifier
311, 312 Conductive connection
32 Electrical storage element
41, 43 Mechanical coupling
42 Mechanical excitation
5 Resonance system (electromechanical transducer)
51 Oscillation device
6, 6a, 6b, 6c Activators
60 Container for the compressed air
61 Conveyor
62a, 62b Transport rollers
65 Air inlet opening
66 Valve
68 Air current
69 Air outlet opening
7 External mechanical force
71 Accumulator for mechanical energy
8a, 8b Oscillating elements
9a, 9b Weights
10a, 10b, 10c External electrodes of piezoelectric element 2
11 Piezoelectrical layer
12 Internal electrodes
15a, 15b Lead
16 Ring
17 Mounting region
AA Rotational axis
U Voltage after the rectifier
U_{ref} Reference voltage
U₁ Voltage produced in the first electromechanical transducer
U_{N} Voltage in the N-th electromechanical transducer
fₐ Excitation frequency
f_{a,0} Initial value of excitation frequency
f_{a,1} The excitation frequency which corresponds to the operating point
f_{a,R} Excitation frequency which is equal to the whole multiple of the resonance frequency
f_{R} Resonance frequency
t Time
x First lateral direction, which matches the longitudinal direction of the oscillating elements 8a, 8b
y Second lateral direction
z Vertical direction

### DETAILED DESCRIPTION

FIG. 1 shows the schematic design of a piezo-generator 1 with a mechanical resonance system 5 that comprises an oscillation device 51 and a piezoelectric transducer 2 (piezoelectric element). The resonance system 5 has a resonance frequency f_{R}.

The oscillation device 51 and the piezoelectric element 2 are coupled mechanically to each other. The mechanical coupling between the oscillation device 51 and the piezoelectrical transducer 2 is identified with the double arrow 43. The transfer of mechanical energy to the piezoelectrical transducer is possible due to this coupling.

The oscillation device 51 can be excited into oscillation by means of an activator 6. The oscillation frequency preferably matches the resonance frequency f_{R} of the resonance system. The activator 6 is a movable part which receives the energy of an external mechanical force 7 and meters this, i.e., transfers it to the oscillation device 51 at an excitation frequency fₐ and thus brings this device into oscillation. Preferably, fₐ≈f_{R}/n, where n is a whole number between 1 and 5.

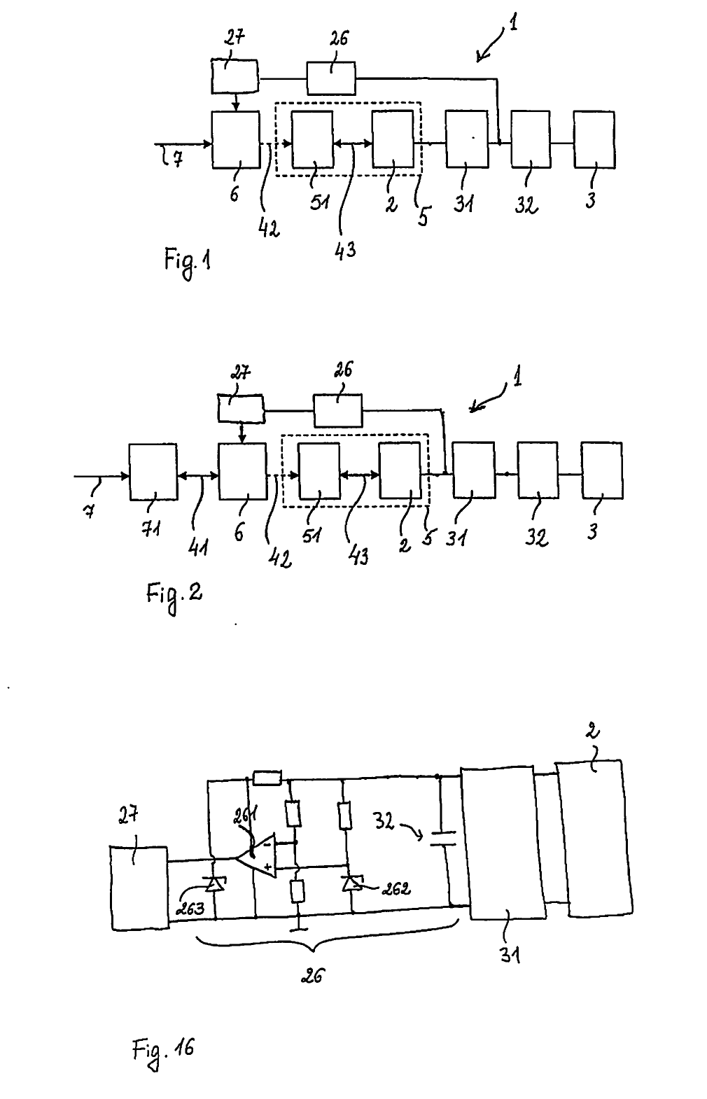

In FIG. 2, a variant of piezo-generator 1 is shown which comprises an energy accumulator 71 in which the mechanical energy produced by the external mechanical force 7 is stored. The energy accumulator 71 is coupled with the activator 6 or with a transport device for the transport of the activator, which is shown in FIG. 2 with the arrow 41.

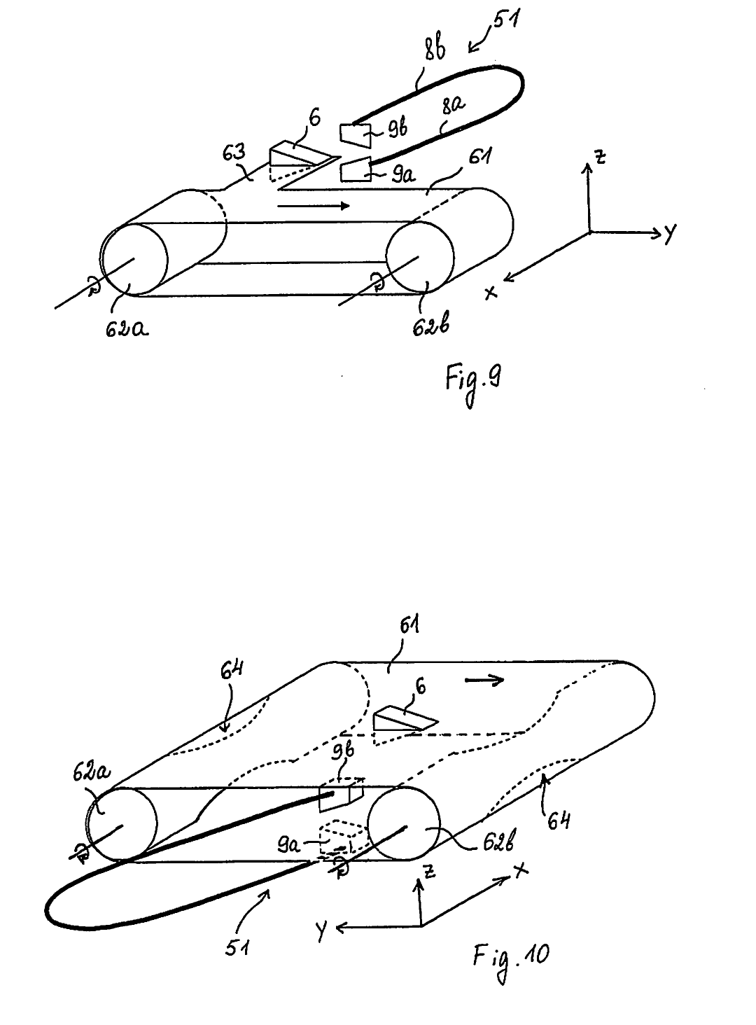

The activator 6 can be used for the deflection of oscillatable elements of the oscillation device 51. In that case, a mechanical contact 42 can exist between the activator 6 and the oscillation device 51 at the specified time intervals. The activator 6 is conceptualized as a valve for releasing the compressed air from the energy accumulator 71. This activator can excite the oscillation device 51 even without contact, wherein, as shown in FIG. 13 with the arrow 68, an air current is produced in the direction of the main areas of the oscillatable elements at the prescribed time intervals.

In one variant, the energy of translational or rotational movement of activator 6 is converted into oscillations of the oscillation device 51. The oscillation device 51 transfers a variable compressive strain to the piezoelectric element during the oscillation. The piezoelectric element is connected electrically with an electrical load 3-consumer. In the piezoelectric element, the transformation of mechanical energy into electrical takes place. The electrical energy is fed to the electrical load 3. In principle, the piezoelectric element can have any arbitrary design.

The piezoelectrical transducer 2 is preferably coupled electrically to the activator 6 or to a transport device, which is explained in FIGS. 9-12, for the transport of activator 6, by means of a feedback loop. A part of the voltage produced in the piezoelectric element is conducted in the feedback loop, in which a feedback circuit 26 is arranged.

An AC voltage is produced at the piezoelectric element. The piezo-generator 1 can be provided for the production of an AC voltage. The piezo-generator 1 can, however, also be used for the production of a DC voltage. A rectifier 31 is provided for producing the DC voltage from the AC voltage. Many branches, with each having an independent resonance system, can be connected in parallel for producing the DC voltage, wherein the AC voltage is produced with different phases in different branches.

The signal which is produced at the piezoelectric element is rectified by means of a rectifier 31, and is preferably stored at the electrical storage element 32. A diode circuit with at least one diode is suitable as a rectifier 31. A circuit which comprises at least one capacitor or storage battery is especially suitable as an electrical storage element 32. The electrical energy stored in the storage element 32 can be used by the load 3.

A part of the signal produced is used for feedback. In that case, a control signal is produced at the output of the feedback circuit 26 for controlling the metering device 27. The metering device 27 comprises a mechanism whose frequency or speed can be adjusted with the control signal of the feedback circuit 26. This mechanism is coupled mechanically to a transport device on which the activator 6 is fixed; see FIGS. 9 and 10. The mechanical parameters of the metering device 27 can be modified such that the excitation frequency fₐ can be adjusted to correspond to the operating point.

In all shown variants, the feedback signal for the feedback circuit 26 can be tapped at the output of the rectifier 31, as in FIG. 1. The feedback signal can alternatively be tapped, as in FIG. 2, between the piezoelectric transformer 2 and the rectifier 31, i.e., at the input of the rectifier.

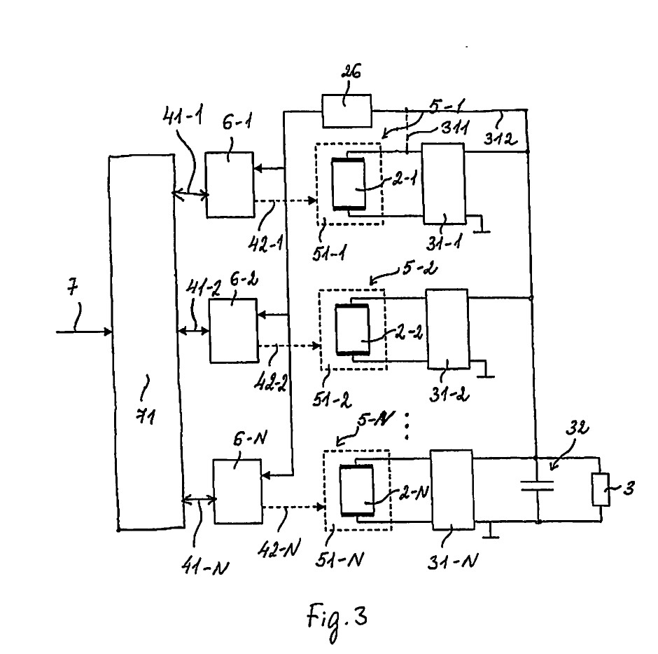

FIG. 3 shows an example piezo-generator which comprises N parallel connected branches, wherein a resonance system 5-1, 5-2 . . . 5-N is arranged in each branch, and where N>1. A piezoelectric element 2-i and a rectifier 31-i are arranged in the i-th branch. i is the ordinal number of the branch; i=1, 2 . . . N. All branches are preferably connected to a common energy accumulator 32 for electrical energy (here, a capacitor).

Each piezoelectric element 2-i is coupled mechanically to an oscillation device 51-i. A feedback circuit 26 is connected for at least one branch, preferably at the output of the rectifier 31-i. This is the first (top) branch in FIG. 3.

A feedback circuit 26 is connected to at least one branch, preferably at the output of rectifier 31-i. Alternatively, the tapping of the feedback signal for the feedback circuit can take place before the rectifier circuit, as in the variant according to FIG. 2. In the latter case, the conductive connection 312 is replaced by a conductive connection 311, which is shown in FIG. 3 with a dashed line.

An activator 6-1, 6-2 . . . 6-N is provided for excitation of the resonance systems of the respective branches. Preferably, each activator is mechanically coupled to a common energy accumulator 71, as is shown with arrows 41-1, 41-2 and 41-N. The activators 6-1, 6-2 . . . 6-N are controlled by means of the feedback circuit 26 such that in each generator branch, the excitations 42-1, 42-2 . . . 42-N and the resonance systems 5-1, 5-2 . . . 5-N are synchronized with each other.

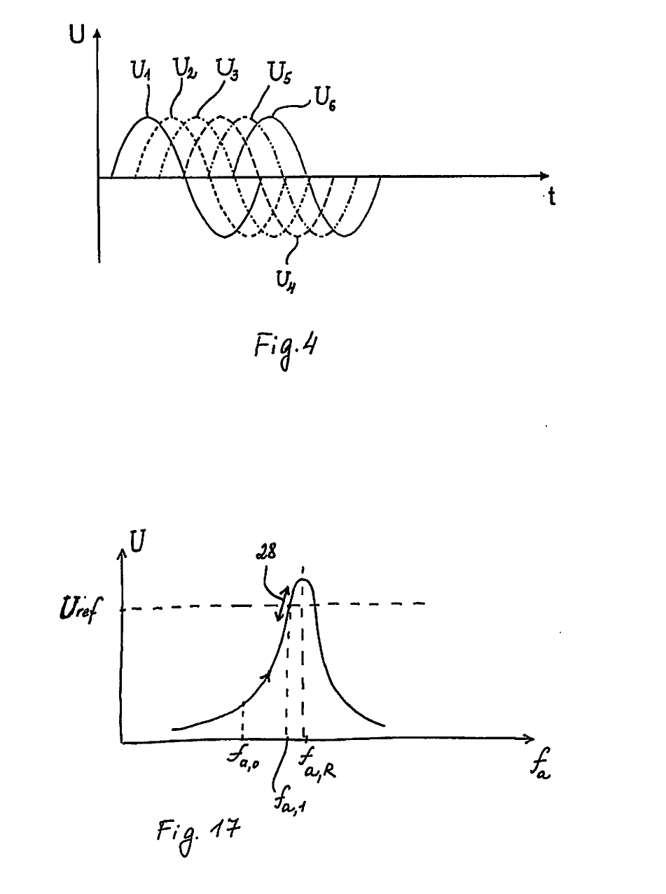

The resonance systems of different branches are preferably constructed in the same way, and are controlled with the same frequency but different phases. FIG. 4 shows the chronological progression of the voltage U which is generated by the electromechanical transducers connected in parallel according to FIG. 3. The voltage U₁, U₂ etc., is produced by the piezoelectric elements 2-1, 2-2 etc. The phases of U₁, U₂ are shifted relative to each other. It is thus possible to smooth the amplitude fluctuation (pulsation) of the output voltage of the generator.

FIG. 5 shows another embodiment of the piezo-generator with many parallel-connected piezoelectric elements 2-1, 2-2 . . . 2-N. Each rectifier 31-1, 31-2 . . . 31-N can incorporate a diode in the series branch and a diode in the parallel branch, as shown in FIG. 5. Here, a transport device 6′ is controlled by means of the feedback circuit 26 to which the activators 6-1, 6-2 . . . 6-N are coupled. The paths of the activators preferably run parallel to each other. For this, a transport device with a conveyor which is illustrated in FIGS. 9 and 10 is especially well-suited. Different activators are spatially shifted relative to each other in FIGS. 9, 10, preferably in the y-direction. It is also possible to arrange different oscillation devices one after another in the y-direction along the path of activator 6, and it is thus possible to excite different oscillation devices with different phases, but with the same activator 6.

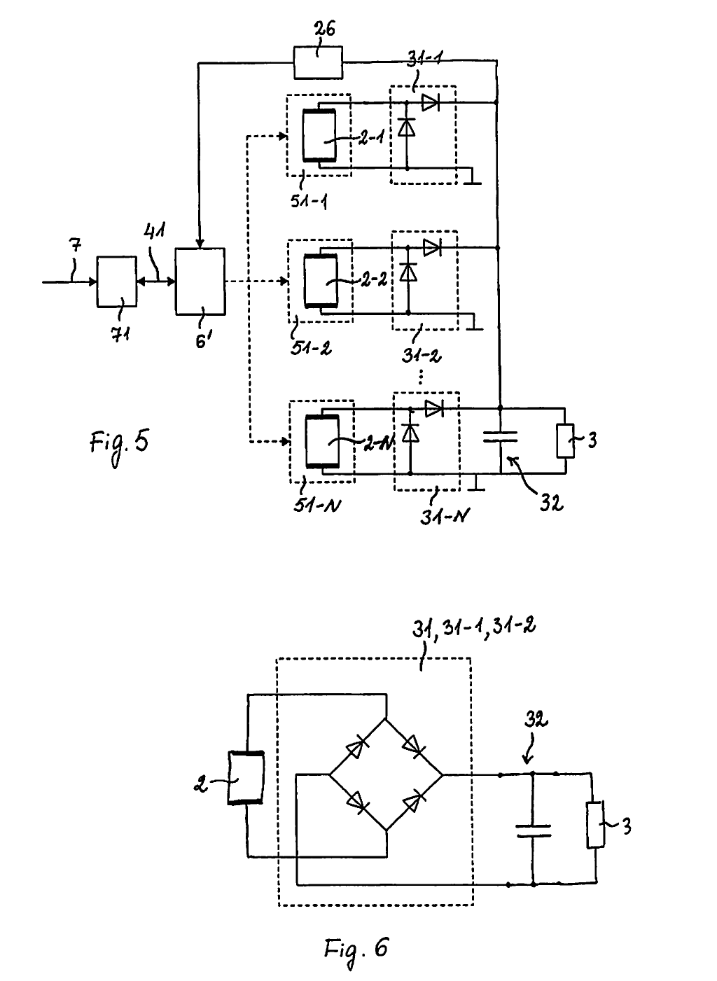

FIG. 6 shows in detail a piezo-generator with a rectifier 31, and/or 31-1, 31-2 . . . 31-N, in the form of a diode bridge. There the input of the diode bridge is connected to the piezoelectric element 2, and its output is connected to the energy accumulator 32 and/or the load 3.

FIG. 7 shows an embodiment of the piezo-generator with many parallel-connected piezoelectric elements, wherein an independent activator is provided for excitation of each resonance system. An independent feedback circuit 26-1, 26-2 . . . 26-N is connected to the piezoelectric element with the ordinal number i=1, 2 . . . N; this feedback circuit is provided for synchronization of the respective activators 6-1, 6-2 . . . 6-N and of the resonance system which is to be excited by these. Apart from that, the functioning of the arrangement shown in FIG. 7 is explained in conjunction with FIG. 3.

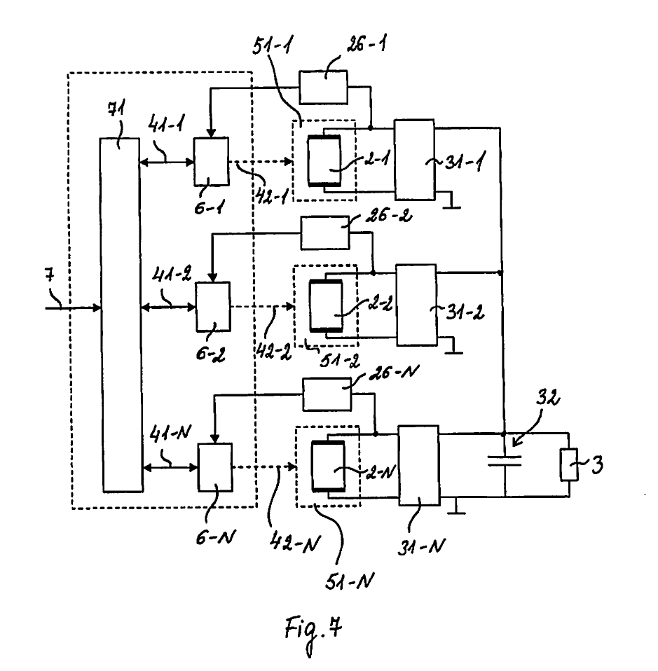

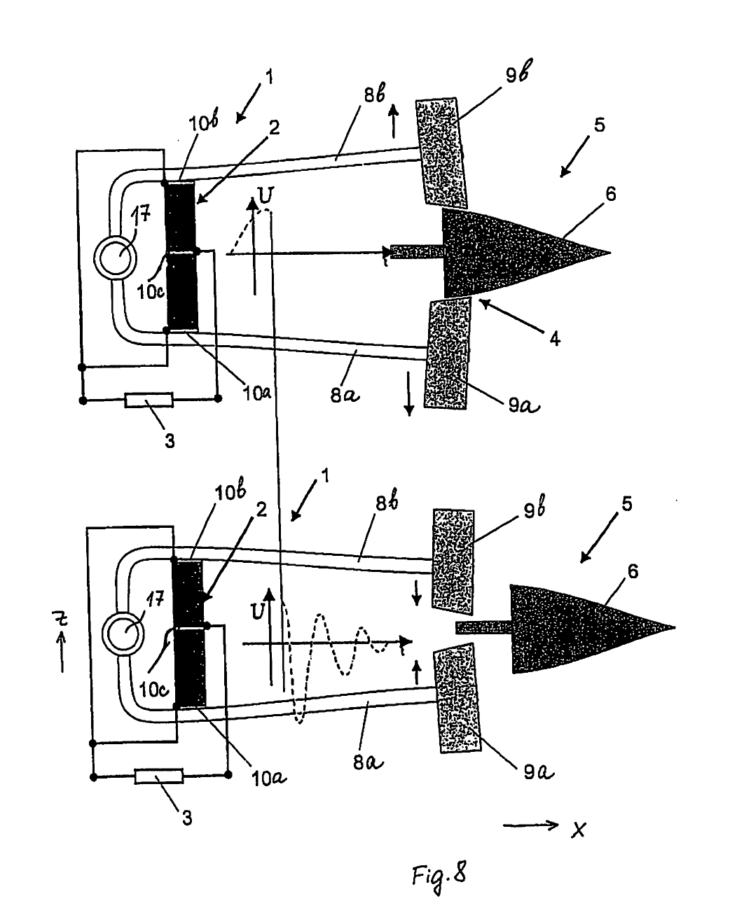

FIG. 8 shows an example implementation of the piezoelectric generator with an oscillation device which is in the shape of a tuning fork, i.e., it is designed as a U-piece. The U-piece has two legs and a connecting part which connects the two legs to each other. The legs of the U-piece are oscillation elements 8a, 8b which represent the wings of the oscillation device. The oscillations of the second oscillating element 8b are correlated with the oscillations of the first oscillating element 8a.

The connecting part of the U-piece has a mounting area 17 at which the oscillation device is fixed on a carrier (not shown) such as the housing of the generator.

In the initial state, the piezoelectric element 2 is clamped between the wings (legs) of the oscillation device close to the connecting part, and is thereby pre-stressed. In one variant, the piezoelectric element 2 is held exclusively by the legs of the oscillation device. It is also possible, however, to use the wings mainly for periodic compression of piezoelectric element 2, where the piezoelectric element is supported, held or carried by an extra fixture mechanically decoupled from the oscillation device.

The legs of the oscillation device are, for example, band-shaped cantilever springs. The oscillation device moreover comprises weights 9a, 9b which are mounted at the free ends of the respective oscillating elements 8a, 8b, and are suitable for storing mechanical energy.

In the contact region, the weights 9a, 9b and the activator 6 preferably have slanted surfaces facing each other; these surfaces stop abruptly at a location which is the last point of contact during sliding of the activator from the contact region. The maximum deflection of oscillating elements 8a, 8b is achieved at this point. The slanted surfaces preferably intersect each other with a horizontally-oriented plane. Advantageously, an abrupt release of these oscillating elements is brought about in this way during passage of the activator 6 through the contact region of the oscillating device directly after the maximum deflection of oscillating elements 8a, 8b is achieved. It is thus possible to transfer the mechanical energy to the oscillation device in the most efficient manner.

The activator 6 can in particular be designed in the shape of a wedge. The activator 6 moves from left to right between the weights 9a, 9b in FIG. 8, and slides on the surfaces of these weights that are facing it. As soon as the cross-sectional dimension of the activator exceeds the minimum distance between the weights 9a, 9b, the weights 9a, 9b are pressed apart from each other, as is shown at the top of FIG. 8 with arrows.

The weights 9a, 9b are beveled on the sides facing each other such that sliding of the wedge between these weights is facilitated. Due to the wedge shape of activator 6 and the bevel of weights 9a, 9b, it is possible to press the oscillating elements 8a, 8b apart very efficiently and in a shock-free manner. The activator 6 can also move perpendicular to the cross-sectional plane shown in FIG. 8, where the bevel of weights 9a, 9b preferably always runs along the direction of motion of activator 6.

The deflection of oscillating elements 8a, 8b, caused by movement of the activator, stores energy in these oscillating elements. As soon as the activator leaves the contact region of the oscillation device, the weights start to move in the opposite direction under the effect of a restoring force. The direction of motion of oscillating elements 8a, 8b immediately after the activator slides out from the contact region is shown at the bottom of FIG. 8 with arrows. The energy stored in the weights 9a, 9b is thereby converted into the oscillation energy of these weights or the oscillation energy of the oscillation device, since the motion of weights 9a, 9b brings about the oscillation of oscillating elements 8a, 8b.

During the oscillation period of the oscillating elements 8a, 8b, the piezoelectric element 2 experiences mechanical compressive stress in the vertical direction z; this stress changes periodically with respect to time and leads to the contraction of the piezoelectric element. The compressive stress which is produced at the piezoelectric element 2 is converted into electrical energy, e.g., as explained below. Due to the piezoelectric effect, an electrical charge appears at the electrodes 10a, 10b, 10c of the piezoelectric element 2 which is fed to the electrical load 3 or to the energy accumulator. The front-side electrodes 10a and 10b are both connected to a first electrode, and the middle electrode 10c of piezoelectric element is connected to a second electrode of load 3, so that the electrical charge can flow out from the piezoelectric element 2.

The AC voltage U measured at the piezoelectric element 2 as a function of time t is shown schematically in FIG. 8. This voltage is proportional to the amplitude of the mechanical oscillations of the oscillating elements 8a, 8b. This amplitude diminishes with time since the oscillations are damped due to frictional losses and energy coupling.

The oscillating elements 8a, 8b preferably oscillate in opposition relative to each other, but with the same amplitude. The region of the connecting part that lies close to the axis of symmetry of the oscillation device remains essentially immovable during oscillation of the oscillating elements 8a, 8b. The mounting region 17 is preferably arranged in this region of the connecting part. Thus the oscillations of the oscillating elements 8a, 8b are damped only negligibly by the connection to the carrier.

The piezoelectric element 2 shown in FIG. 8 is a multilayered component and/or a piezostack, i.e., a stack of piezoelectrical layers and metallic layers arranged in an alternating manner. Each metallic layer is designed as an internal electrode. The first internal electrodes, not shown in FIG. 8, are connected to a first external electrode 10a, the second internal electrodes to a second external electrode 10b, and the third internal electrodes to a third external electrode 10c. The external electrodes 10a, 10b, 10c are arranged on the surface of the piezoelectric element 2.

A mechanical arrangement for the excitation of oscillation device 51 is shown in FIGS. 9 and 10 in which, when compared to the variant shown in FIG. 8, the activator (not shown) does not run along the longitudinal direction x of the oscillating elements 8a, 8b, but rather runs along another, lateral direction y, i.e., transverse to it. In that case, the weights 9a, 9b are beveled such that the distance between them decreases in the y-direction.

The oscillation frequency of the oscillation device 51 can be adjusted by the mass of the weights 9a, 9b, the lengths of the oscillating elements 8a, 8b, and the position of the piezoelectric element 2. The oscillation frequency is preferably equal to the resonance frequency of the piezoelectric element 2.

The excitation of the oscillation device 51 by the activator 6 can be periodic, wherein the period of excitation is preferably equal to the oscillation period of the oscillation device 51 or is a whole multiple of this period. The period of excitation can be reduced if need be, and thus the excitation frequency can be increased, if many activators 6, 6a, 6b, 6c, preferably of the same type, are used in place of only one activator 6 as in the variants according to FIGS. 11 and 12, wherein the sequential activators are arranged at the same distance from each other on a transport device. The transport device can comprise a conveyor as in FIGS. 9 and 10 or can comprise a rotating device as in FIGS. 11 and 12.

A transport device is introduced in FIGS. 9, 10 which displaces the activator 6 in the y-direction, i.e., from left to right, in a linear manner. The transport device comprises a conveyor 61 on which the activator 6 is fixed. In addition, another activator 6a is fixed on this belt.

The transport rollers 62a, 62b rotate in the clockwise direction about a rotational axis, and thus cause movement of the conveyor 61, also in the clockwise direction. In the variant according to FIG. 9, the conveyor 61 has a laterally-projecting tongue 63 on which the wedge-shaped activator 6 is fixed. The tongue 63 projects in the direction transverse to the direction of motion of the conveyor 61 and/or of activator 6. When the activator passes through the contact region of oscillation device, the deflection of weights 9a, 9b that was explained in conjunction with FIG. 8 is brought about.

In FIG. 10, the bottom part of the conveyor 61 is arranged between the oscillating elements 8a, 8b. Here, the activator 6 is, when compared to the variant according to FIG. 9, arranged in the central region of the conveyor 61. At the same time, to facilitate the unhindered passage of the part of activator 6 that faces inward in the region of the transport rollers, each of the transport rollers 62a, 62b has a region 64 with a smaller cross-section than the region provided for belt transport. The path of activator 6 passes between the weights 9a, 9b.

The oscillation device 51 shown in FIGS. 9 and 10 is also shown in a side view in FIG. 13.

The activator can be mounted on a rotating device in place of a conveyor belt, as in the variants according to FIGS. 11 and 12. Many activators can be mounted on the rotating device, by means of which the excitation frequency for a constant rotary frequency of the rotating device can be increased when compared to the variant with only one activator. The arrangement of the rotating device and of the activators is preferably point-symmetrical with respect to its center point on the rotational axis.

In FIG. 11, the rotating device is realized as a disk 16c which rotates about an axis which is perpendicular to the main planes of the disk. Alternatively, the rotating device can have at least one crosspiece 16a, as in the variant according to FIG. 12; this crosspiece is perpendicular to the rotational axis and can be rotated about the rotational axis. The rotational axis passes through the center of the crosspiece 16a. An activator is fixed at each end of the crosspiece 16a.

In each case, a section of the path of each activator 6, 6a, 6b, 6c runs between the oscillating elements 8a, 8b.

FIG. 13 shows an oscillation device 51 which can be excited by compressed air and shows an accumulator 71 for the compressed air. The accumulator 71 comprises a container 60 with an air inlet opening 65 which can be closed by a valve 66 and an air outlet opening 69 which can be closed by the activator 6.

Air can be pumped into the container 60 in which the valve is open. The valve 66 is opened only when air pressure builds up in the region of the inlet opening 65 in the direction from the outside toward the inside. Valve 66 prevents the air from escaping from the container 60 through the inlet opening 65.

The outlet opening 69 is opened by the activator 6 in the first time interval provided for the same. The escape of air through the outlet opening 69 is prevented in the second time interval by the activator 6. The activator 6 is a valve which can be controlled by means of the feedback loop shown in FIGS. 1-3, 5 and 7.

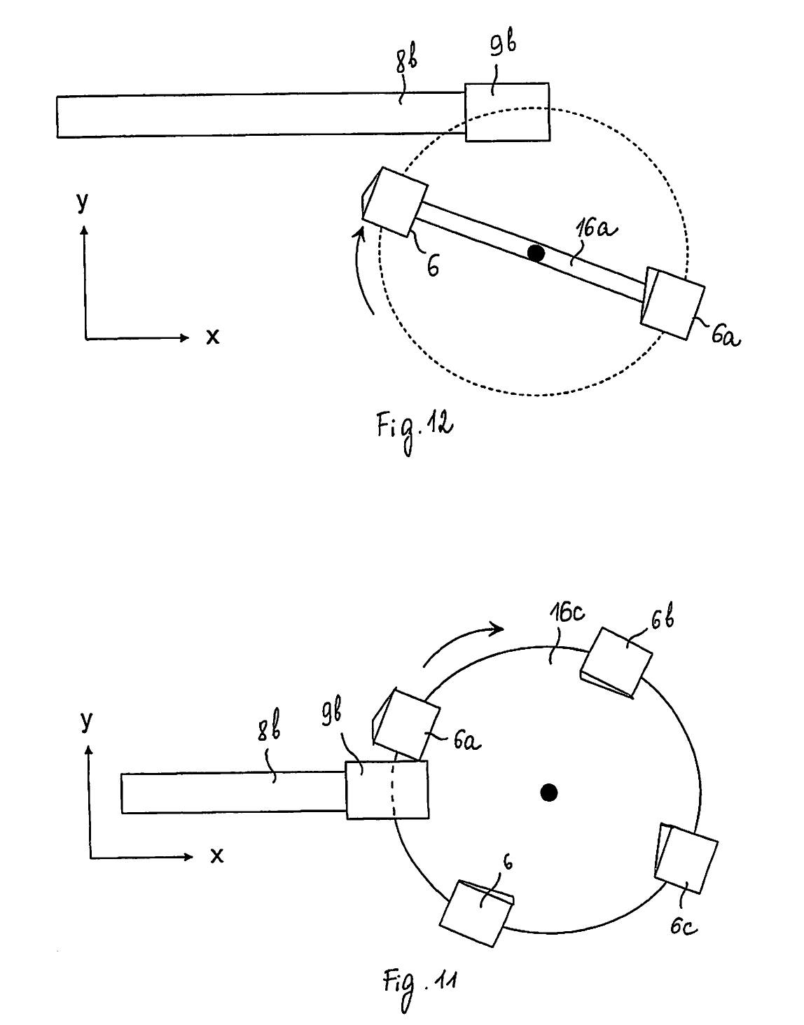

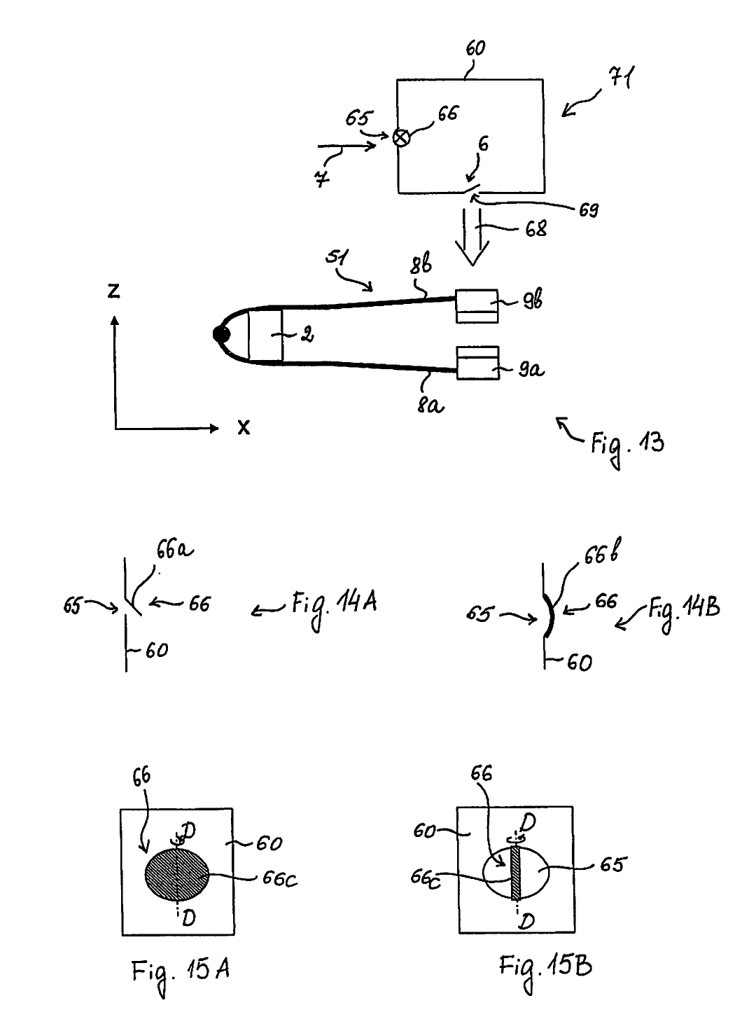

Different examples for valves 6 or 66 are shown in FIGS. 14A, 14B and 15A, 15B. FIG. 14A shows in detail the air reservoir according to FIG. 13 with valve 66 formed as a flap 66a which is fixed at one end of the air reservoir. FIG. 14B shows the valve formed as a membrane 66b.

FIGS. 15A and 15B show the view of an inlet opening of air container 60 with a valve in the shape of a plate 66c which can be rotated about its central axis DD for a closed (FIG. 15A) and an open (15B) inlet opening. In FIG. 15A, the plane of plate 66c is transverse, and in FIG. 15B, is arranged parallel to the normal of opening 65.

FIG. 16 shows an exemplary embodiment of the feedback circuit. The feedback circuit 26 comprises a comparator 261. A reference voltage U_{ref} is applied to the non-inverted input of the comparator. The reference voltage is supplied by means of the electrical storage element 32 and is stabilized by means of Z-diode 262. The reference voltage fixes the operating point of the resonance system. The voltage U which is picked up at the output of rectifier 31 is applied to the inverted input of comparator 261.

The supply voltage of the comparator is provided by the electrical storage element 32 and is stabilized by means of Z-diode 263.

The output signal of comparator 261 is used for controlling the metering device 27. The output signal of the comparator can be used, for example, for switching an electromechanical element with which the mechanical properties of the metering device can be adjusted.

The comparator can comprise a built-in amplifier. The output signal of the comparator can also be amplified with a separate amplifier, not shown in FIG. 16.

FIG. 17 shows voltage U as a function of excitation frequency fₐ. This voltage, which is measured at the input of the comparator, is proportional to the voltage which is produced at the output of the rectifier. f_{a,0} is the initial value of the excitation frequency and f_{a,1} is the excitation frequency which corresponds to the operating point. The frequency f_{a,0} is fixed by the mechanical parameters of the metering device 27 in the resting state.

f_{a,R} is the excitation frequency which is equal to a whole multiple of the resonance frequency. In this example, the frequency f_{a,0} and the operating point were selected below the frequency f_{a,R} with which the maximum voltage can be produced. During the transient phase, the parameters of the metering device 27 are changed such that the excitation frequency is increased up to the value f_{a,1} with which the voltage level U_{ref} is achieved; this level was specified at the second input of the comparator. When this level is exceeded, the excitation frequency is reduced by switching of the comparator, and when it repeatedly falls below this level it is again increased so that the excitation frequency is stabilized in the vicinity of the operating point. The negligible frequency change close to the operating point is shown in FIG. 17 with a double arrow 28.

The resonance system is not restricted to the embodiments shown. Optional configurations of the piezoelectric element and the oscillation device are possible.

What is claimed is:

1. A piezo-generator comprising:
a resonance system that can be excited by mechanical oscillations, the resonance system comprising a piezoelectrical transducer;
a feedback circuit electrically connected to the piezoelectrical transducer; and
a device for excitation of the resonance system, the device controlled with the feedback circuit.

2. The piezo-generator according to claim 1,
wherein the resonance system has a natural frequency, and
wherein the device for exciting the resonance system is suitable for adjusting a frequency of mechanical oscillations at the natural frequency of the resonance system.

3. The piezo-generator according to claim 1, further comprising at least one activator for the excitation of mechanical oscillations of the resonance system, wherein the feedback circuit is provided for regulating an action frequency of the activator on the resonance system.

4. The piezo-generator according to claim 3, further comprising an energy accumulator for mechanical energy in the form of a spring, the energy accumulator being mechanically coupled to the activator.

5. The piezo-generator according to claim 3, further comprising an energy accumulator for mechanical energy in the form of compressed air, wherein the activator is designed as a valve which is suitable for releasing the compressed air, and wherein with the valve open an air pressure is generated onto parts of the resonance system capable of oscillation.

6. The piezo-generator according to claim 3, further comprising a transport device on which the activator is fixed, wherein the feedback circuit is provided for adjusting a specified speed of the transport device.

7. The piezo-generator according to claim 1, wherein the resonance system comprises an oscillation device which has oscillating elements that oscillate counter to each other, the piezoelectrical transducer being clamped between the oscillating elements.

8. The piezo-generator according to claim 7, further comprising at least one activator for the excitation of mechanical oscillations of the resonance system, wherein the activator is suitable for changing the distance between the oscillating elements.

9. The piezo-generator according to claim 7, wherein the oscillating elements each have a weight in a region of freely oscillating ends of the oscillating elements.

10. The piezo-generator according to claim 7, wherein the oscillating elements can be magnetized such that they can be deflected electromagnetically by the feedback circuit.

11. The piezo-generator according to claim 3, wherein the feedback circuit is suitable for the production of control pulses with which the activator is driven.

12. The piezo-generator according to claim 1, wherein the feedback circuit comprises an amplifier.

13. The piezo-generator according to claim 1, further comprising an electrical energy accumulator for storing electrical energy produced in the piezoelectrical transducer.

14. The piezo-generator according to claim 13, wherein the electrical energy accumulator is provided to supply energy to the feedback circuit.

15. The piezo-generator according to claim 14, wherein the feedback circuit comprises a comparator, and wherein the electrical energy accumulator is used to produce a reference voltage for the comparator.

16. The piezo-generator according to claim 1, further comprising a rectifier electrically connected to the piezoelectrical transducer.
